(19) United States
(12) Patent Application Publication
(10) Pub. No.: US 2018/0071865 A1
(43) Pub. Date: Mar. 15, 2018

(54) LASER MACHINING DEVICE AND LASER MACHINING SCRAP REMOVAL DEVICE

(71) Applicant: INDUSTRIAL TECHNOLOGY RESEARCH INSTITUTE, Hsinchu (TW)

(72) Inventors: Chun-Ming CHEN, Hsinchu (TW); Min-Kai LEE, Hsinchu (TW); Chun-Ping JEN, Hsinchu (TW)

(73) Assignee: INDUSTRIAL TECHNOLOGY RESEARCH INSTITUTE, Hsinchu (TW)

(21) Appl. No.: 15/409,226

(22) Filed: Jan. 18, 2017

(30) Foreign Application Priority Data
Sep. 9, 2016 (TW) 105129291

(51) Int. Cl. B23K 26/16; B23K 26/388; B23K 37/08

(52) U.S. Cl. CPC B23K 26/16; B23K 37/08; B23K 26/388

(57) ABSTRACT

A laser machining device includes a laser generating component, a light moving component, a gas source and a laser machining scrap removal device. The laser generating component generates a laser beam passing through an optical channel. The light moving component is positioned along a path of the laser beam to make the laser beam move along an annular machining path. The laser machining scrap removal device utilizes an internal flow path of the nozzle to increase the speed of the ejected airflow and reduce the pressure of a suction area. The gas source provides an airflow and is located on the laser machining scrap removal device in communication with the internal flow path of the nozzle. The laser machining scrap removal device induces suction on the laser processed area to assist in laser cutting/drilling processes by removing large areas of scrap, thereby improving the production speed and hole quality.

### CROSS-REFERENCE TO RELATED APPLICATION

The present disclosure is based on, and claims priority from, Taiwan Application Number 105129291, filed Sep. 9, 2016, the disclosure of which is hereby incorporated by reference herein in its entirety.

### TECHNICAL FIELD

The present disclosure relates to laser machining devices and laser machining scrap removal devices, and, more particularly, to a laser machining device and a laser machining scrap removal device for large scale processing.

### BACKGROUND

With the rapid development in the touch panel industry, protective glass substrates are becoming thinner and their strengths are enhanced. The traditional CNC mechanical drilling process is facing a bottleneck. On the other hand, non-contact laser drilling technology capable of drilling on high-strength substrates is gradually gaining popularity over traditional CNC mechanical drilling process.

Laser drilling can be generally divided into small-area single-point drilling and large-area regional drilling. Traditional laser nozzles are typically designed for single-point drilling. The diameter of the drilling range is typically less than 2.5 mm. If large-area regional drilling (with a diameter greater than 10 mm or more) is desired, a biaxial (X-axis and Y-axis) mobile platform is required in conjunction with the traditional laser nozzle in order to realize large-area regional drilling. However, since the biaxial mobile platform moves at a relatively low speed, it is difficult to raise the production speed of the laser drilling process. In view of this, galvanometric scanner is also used in cooperation with the traditional laser nozzle in the hope of increasing the drilling efficiency with high scanning frequency of the galvanometric scanner.

In theory, the conventional laser nozzle and the galvanometric scanner together may increase the drilling speed, but in actual practice, the drilling speed of the conventional laser nozzle in conjunction with the galvanometric scanner is limited by the scrap removal speed. More specifically, scrap removal is currently done through gas. The enlargement of the aperture will increase the range the gas could cover. However, expanding the range that can be covered by the gas would result in a decrease in the pressure of the scrap removal gas. This reduces the effectiveness of scrap removal gas, which makes it difficult to improve the drilling efficiency and quality of the laser drilling treatment. Therefore, there is a need for a solution that improves the drilling efficiency and quality of the laser drilling equipment during drilling of large-aperture holes.

### SUMMARY

The present disclosure provides a laser machining device and a laser machining scrap removal device that improve drilling efficiency and quality of the laser drilling equipment during large-scale processing.

In a laser machining device and a laser machining scrap removal device disclosed in an embodiment of the present disclosure, the laser machining device includes a laser generating component, a light moving component, a gas source and the laser machining scrap removal device. The laser generating component is used for generating a laser beam. The light moving component is positioned along the path of the laser beam to make the laser beam move along an annular machining path. The laser beam passes through an optical channel. The gas source is located on the laser machining scrap removal device for providing an airflow.

In accordance with the laser machining device and the laser machining scrap removal device described in the embodiment above, with a design of the internal flow path of the laser machining scrap removal device, the speed of the ejected gas is increased, which lowers the pressure of the suction region and produces suction for the area of the workpiece being laser treated, thereby achieving scrap removal, and in turn, improving the drilling efficiency and quality of the laser machining device. Moreover, a plurality of gas inlets can also be provided on the laser machining scrap removal device to enable a plurality of flow channels simultaneously. As such, the laser machining scrap removal area is increased, and a large-area laser machining scrap removal device is realized.

### BRIEF DESCRIPTION OF THE DRAWINGS

The present disclosure can be more fully understood by reading the following detailed description of the preferred embodiments, with reference made to the accompanying drawings, wherein:

FIG. 1A is a partial cross-sectional diagram illustrating a laser machining device in accordance with a first embodiment of the present disclosure.

FIG. 1B is a cross-sectional diagram illustrating the laser machining device and a workpiece in accordance with the first embodiment of the present disclosure.

FIG. 2A is a cross-sectional diagram illustrating the laser machining scrap removal device.

FIG. 2B is a partial isometric diagram of FIG. 2A.

FIG. 3 is a partial isometric diagram illustrating a laser machining scrap removal device having a plurality of gas inlets.

### DETAILED DESCRIPTION

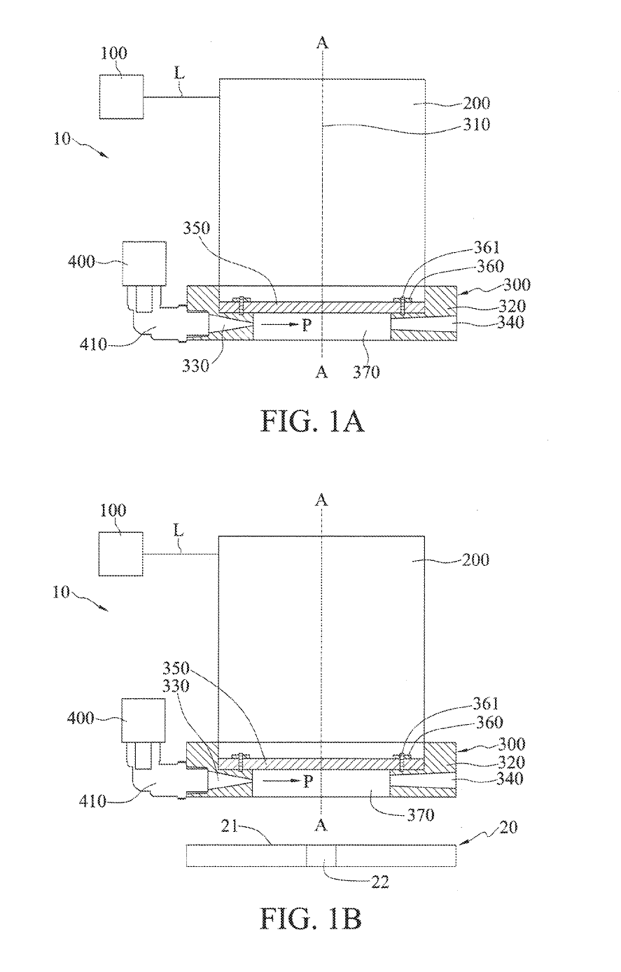

Referring to FIGS. 1A and 1B, FIG. 1A is a partial cross-sectional diagram illustrating a laser machining device in accordance with a first embodiment of the present disclosure, and FIG. 1B is a cross-sectional diagram illustrating the laser machining device and a workpiece in accordance with the first embodiment of the present disclosure. FIG. 1A does not include a workpiece 20, whereas FIG. 1B includes the workpiece 20. In an embodiment, the workpiece 20 is not in contact with a laser machining scrap removal device 300. In another embodiment, the workpiece 20 and the laser machining scrap removal device 300 are in contact during processing.

A laser machining device 10 according to the present disclosure performs drilling on the workpiece 20 to form a hole 22 on a surface to be processed 21 of the workpiece 20. The laser machining device 10 includes a laser generating component 100, a light moving component 200, a gas source 400 and the laser machining scrap removal device 300. In an embodiment, the light moving component 200 and the laser machining scrap removal device 300 are integrated as one during operation. In another embodiment, the light moving component 200 and the laser machining scrap removal device 300 operate separately. When the light moving component 200 and the laser machining scrap removal device 300 are operated separately, the laser machining scrap removal device 300 can be situated above the workpiece 20.

The laser generating component 100 is used for generating a laser beam L. In an embodiment, the laser beam L is an ultraviolet laser, a semiconductor green light, a near-infrared laser light or a far-infrared laser light.

In an embodiment, the light moving component 200 is a trepan optical module or a galvanometric scanning module, and is positioned along the optical path of the laser beam L. The laser beam L driven by the light moving component 200 thus moves along an annular machining path. The annular machining path is on the surface to be processed 21 of the workpiece 20, and the annular machining path is the perimeter of the hole 22. In an embodiment, the annular machining path is circular, and the diameter of the annular machining path is greater than or substantially equal to 1 millimeter. In an embodiment, the annular machining path is circular, square, triangular, or star-shaped.

The laser machining scrap removal device 300 includes a space 370, a nozzle 320, at least one gas inlet 330 provided corresponding to one side of the nozzle 320, at least one gas outlet 340 provided on the other side of the nozzle 320, and a protective lens 350. The space 370 is formed underneath the protective lens 350 and between the gas inlet 330 and the gas outlet 340.

An optical channel 310 includes a central axis A. The laser beam L travels through the optical channel 310, and circles inside the optical channel 310 along the annular machining path.

The gas inlet 330 is on one side of the laser machining scrap removal device 300, and is in communication with the space 370.

In an embodiment, for illustration purpose, the gas inlet 330 is one in number. In another embodiment, the gas inlet 330 is two or more in number.

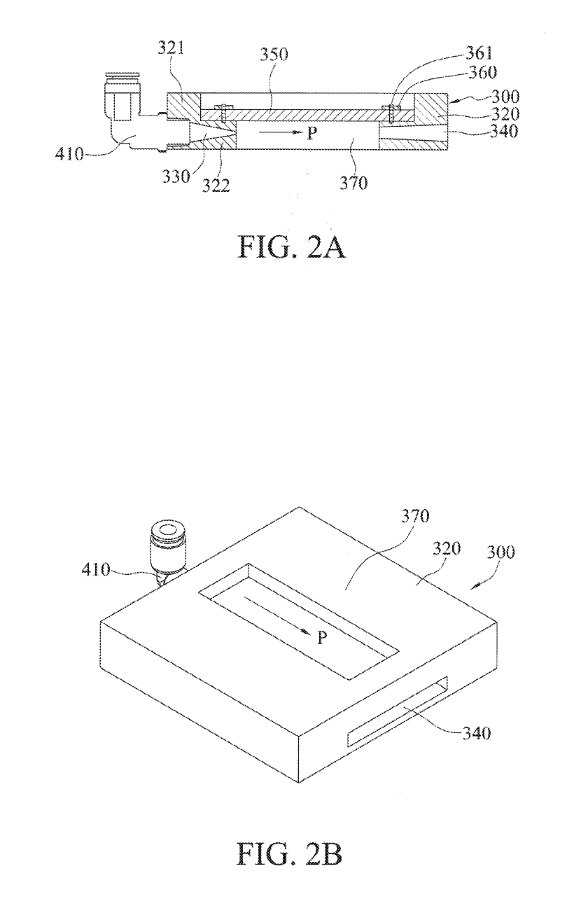

Refer to FIGS. 2A and 2B and FIG. 1B. FIG. 2A is a cross-sectional diagram illustrating the laser machining scrap removal device 300. FIG. 2B is a partial isometric diagram of FIG. 2A. In an embodiment, the laser machining scrap removal device 300 includes the nozzle 320, the at least one gas inlet 330 provided corresponding to one side of the nozzle 320, the at least one gas outlet 340 provided on the other side of the nozzle 320, and a protective lens 350. The protective lens 350 and a fastening piece 360 are secured on the nozzle 320. In an embodiment, a bolt 361 is used for fastening the protective lens 350 and the fastening piece 360 on the nozzle 320, and the space 370 is thus formed between the protective lens 350 and the workpiece 20. In another embodiment, the protective lens 350 is secured on the nozzle 320 through the fastening piece 360 by screws to house the nozzle 320 with the space 370. In an embodiment, the nozzle 320 can be assembled by an upper body 321 and a lower body 322. In another embodiment, the nozzle 320 is formed integrally in one piece. After the upper body 321 and the lower body 322 are assembled, the gas inlet 330 is formed on one side of the nozzle 320 having a tapered aperture, and the gas outlet 340 is formed one the other side having a gradually expanding aperture or a constant aperture. When an airflow P is injected from the gas inlet 330, due to the tapering cross-sectional area of the aperture of the gas inlet 330, the speed of the airflow P is increased. When the airflow P passes through the space 370, the pressure is decreased to less than one atmospheric pressure. As the hole 22 of the workpiece 20 has one atmospheric pressure, a suction region is thus formed in the space 370, and a scrap from the hole 22 of the workpiece 20 is sucked into the space 370, and subsequently repelled from the gas outlet 340 by the high-speed airflow.

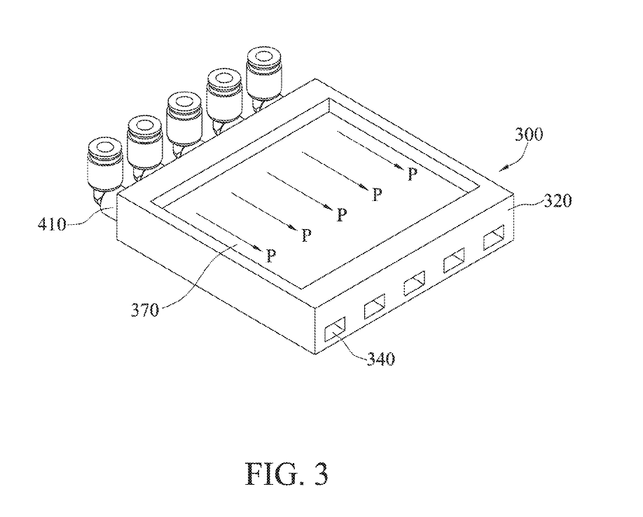

FIG. 3 is a partial isometric diagram illustrating a laser machining scrap removal device 300 having a plurality (e.g., two or more) of gas inlets 330 for use in large-area laser machining scrap removal device 300. Please also refer to FIG. 1B.

The gas source 400 is connected to the plurality of gas inlets 330 of the nozzle 320 via one or more ducts 410 in order to provide a high pressure gas. In an embodiment, the gas is a continuous stream or a pulsed stream.

Furthermore, the airflow P produced by the gas source 400 is turned into high-speed airflow after passing through the tapered gas inlet 330, and this airflow blows any scrap materials in the space 370 towards the gas outlet 340. As such, the efficiency of the airflow P in removing the scrap materials is improved, which helps to increase the drilling efficiency of the laser machining device 10. In actual testing, it takes about 58 seconds to drill a hole having a diameter of 1 mm using a conventional laser machining device, and during the process, dust is accumulated on the surface to be processed of the workpiece. By contrast, it takes about 32 seconds to drill a hole with the same diameter using the laser machining device 10 of an embodiment according to the present disclosure, and no dust is accumulated on the surface to be processed 21 of the workpiece 20 during the process. Moreover, a conventional laser machining device cannot drill a hole having a diameter less than 0.5 mm without the aid of the laser machining scrap removal device 300 according to the present disclosure. It takes about 21 seconds to drill a hole with a diameter of 0.5 mm using the laser machining device 10 of an embodiment according to the present disclosure. Thus, the tests show that the airflow P produced by the laser machining scrap removal device 300 can indeed improve the drilling efficiency and quality of the laser machining device 10.

In accordance with the laser machining device and the laser machining scrap removal device described in embodiments above, with the design of the internal flow path of the laser machining scrap removal device, the speed of the ejected gas is increased, which lowers the pressure of the suction region and produces suction for the area of the workpiece being laser treated, thereby achieving scrap removal, and in turn, improving the drilling efficiency and quality of the laser machining device.

In addition to the design of the internal flow path of the laser machining scrap removal device above, the structure of the laser machining scrap removal device of the present disclosure is simple. By way of suction, contamination resulting from blowing air stream onto the surface of the workpiece can be avoided, this further enhances the drilling efficiency and quality of the laser machining device.

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. A laser machining scrap removal device, comprising:
a nozzle having at least one gas inlet provided at one side of the nozzle and at least one gas outlet provided at the other side of the nozzle; and
a protective lens secured on the nozzle through a fastening piece by screws to house the nozzle with a space formed between the protective lens and a workpiece.

2. The laser machining scrap removal device of claim 1, wherein the space is formed underneath the protective lens and between the gas inlet and the gas outlet.

3. The laser machining scrap removal device of claim 1, wherein the gas inlet has a tapered aperture in communication with the space for a scrap to be sucked from a hole of a workpiece into the space and repelled from the gas outlet.

4. The laser machining scrap removal device of claim 1, wherein the gas inlet is two or more in number.

5. The laser machining scrap removal device of claim 1, wherein the nozzle is assembled by an upper body and a lower body, or integrally formed in one piece.

6. The laser machining scrap removal device of claim 1, wherein the gas outlet has a gradually expanding aperture or a constant aperture.

7. A laser machining device, comprising:
a laser generating component for generating a laser beam;
a light moving component positioned along a path of the laser beam to make the laser beam move along an annular machining path;
the laser machining scrap removal device according to claim 1; and
a gas source provided on the laser machining scrap removal device to provide an airflow.

8. The laser machining device of claim 7, wherein the space is formed underneath the protective lens and between the gas inlet and the gas outlet.

9. The laser machining device of claim 7, wherein the gas inlet has a tapered aperture in communication with the space for a scrap to be sucked from a hole of a workpiece into the space and repelled from the gas outlet.

10. The laser machining device of claim 7, wherein the gas inlet is two or more in number.

11. The laser machining device of claim 7, wherein the nozzle is assembled by an upper body and a lower body, or integrally formed in one piece.

12. The laser machining device of claim 7, wherein the annular machining path is circular, square, triangular, or star-shaped.

13. The laser machining device of claim 7, wherein the annular machining path is circular and has a diameter greater than or substantially equal to one millimeter.

14. The laser machining device of claim 7, wherein the annular machining path is on a surface of a workpiece to be processed by the laser beam.

15. The laser machining device of claim 7, further comprising a duct connecting the gas source to the gas inlet of the nozzle for providing a high-pressure gas with a continuous stream or a pulsed stream.

16. The laser machining device of claim 7, wherein the laser beam is an ultraviolet laser, a semiconductor green light, a near-infrared laser light, or a far-infrared laser light.

17. The laser machining device of claim 7, wherein the light moving component is a trepan optical module or a galvanometric scanning module.

18. The laser machining device of claim 7, wherein the light moving component and the laser machining scrap removal device are detachable.
